(19) United States
(12) Patent Application Publication
(10) Pub. No.: US 2011/0098931 A1
(43) Pub. Date: Apr. 28, 2011

(54) System and method for obtaining and analyzing well data

(76) Inventors: Alexandre G.E. Kosmala, Royston (GB); Allyson Gajraj, Katy, TX (US); Stephen Kimminau, Sudbury (GB); Peter William Walsh, Wentworth Falls (AU)

(21) Appl. No.: 10/520,958

(22) PCT Filed: Jul. 8, 2003
(86) PCT No.: PCT/GB2003/002945

§ 371 Date: Oct. 17, 2006

(30) Foreign Application Priority Data
Jul. 17, 2002 (GB) 0216647.8

(51) Int. Cl. G06F 19/00

(52) U.S. Cl. 702/12

(57) ABSTRACT

A system and method including a sensors deployed in a wellbore, the sensors measuring various downhole parameters. The system retrieves the relevant data from the sensors, validates the data, conditions the data, and analyzes the data to diagnose the wellbore and the reservoir to indicate trends therein. The system has the capability of enabling the characterization of the wellbore and reservoir by being linked to well test analysis tools. The system also has a screening analysis that is much less time consuming than well test analysis tools and that indicates to a user which wellbore and/or reservoirs should be subjected to the more robust and time consuming well test analysis tool.

### BACKGROUND

The invention generally relates to a system and method for obtaining and analyzing well data. In particular, the invention relates to a system and method for obtaining permanent gauge data from a well and analyzing such data in order to determine trends of the reservoir that is linked to the well.

It is now becoming common to deploy sensors within oil and gas wells in order to obtain relevant data from the wells, such as temperature, pressure, and flow rate (to name a few). Once retrieved, the data is analyzed to diagnose the well.

To date, prior art systems have either performed only the retrieval of the data or only the analysis of the retrieved data. No prior art system exists which both retrieves the data from the well and also automatically analyzes such data to diagnose the well and to indicate trends in the relevant reservoir and well.

Moreover, prior art systems called “well test analysis tools” exist which characterize a wellbore or a reservoir thereby providing relevant information and parameters of such wellbore or reservoir to a user. These well test analysis tools are very robust and typically take a substantial amount of time to conduct and complete the analysis of one wellbore or reservoir. It is often difficult to determine which wellbores and reservoirs should be subjected to a well test analysis. In order to save money and time, it would be beneficial to be able to quickly screen which wellbores or reservoirs should be subjected to the time consuming well test analysis.

Thus, there exists a continuing need for an arrangement and/or technique that addresses one or more of the problems that are stated above.

### SUMMARY

According to a first aspect, the present invention consists of a method to retrieve and analyze data from a wellbore, comprising: locating at least one sensor in the wellbore or in communication with fluids produced from the wellbore; measuring at least one parameter of interest with the at least one sensor; retrieving data that is indicative of the at least one parameter of interest from the at least one sensor; loading the data into a computer system; and analyzing the data with the computer system to indicate trends in the wellbore.

According to a second aspect, the present invention consists of a method to screen wellbores in order to determine which wellbores should be subjected to a well test analysis tool, comprising: locating at least one sensor in the wellbore or in communication with fluids produced from the wellbore; obtaining data from the at least one sensor that is indicative of at least one parameter of interest; conducting a quick screening analysis of the data; and determining whether to subject the data to a well test analysis tool depending on the outcome of the conducting step.

According to a third aspect, the present invention consists of a system to retrieve and analyze data from a wellbore, comprising: at least one sensor located in the wellbore or in communication with fluids produced from the wellbore, the at least one sensor measuring at least one parameter of interest; a computer system adapted to retrieve data that is indicative of the at least one parameter of interest from the at least one sensor; and the computer system adapted to analyze the data to indicate trends in the wellbore.#

According to a fourth aspect, the present invention consists of a system to retrieve and analyze data from a wellbore, comprising: at least one central processing unit (CPU); at least one memory in communication with the CPU; the at least one CPU adapted to load data from a wellbore, the data indicative of at least one parameter of interest; and the at least one CPU adapted to analyze the data by using routines stored in the at least one memory in order to indicate trends in the wellbore.

According to a fifth aspect, the present invention consists of a method to screen wellbores in order to determine which wellbores should be subjected to a well test analysis tool, comprising: using a central processing unit (CPU) to load data, the data indicative of at least one parameter of interest in a wellbore; conducting a quick screening analysis of the data with the CPU; restricting the analysis with certain rules and assumptions to ensure the analysis is not a characterization tool; and determining whether to subject the data to a well test analysis tool depending on the outcome of the conducting step.

Advantages and other features of the invention will become apparent from the following description, drawing and claims.

### BRIEF DESCRIPTION OF THE DRAWING

FIG. 1 is a well schematic including the sensors and computer system of the invention and overall system.

FIG. 2 is a schematic of the method performed by the overall system.

FIG. 3 is a more detailed illustration of the load raw data step of the method of FIG. 2.

FIG. 4 is a more detailed illustration of the validate data step of the method of FIG. 2.

FIG. 5 is a more detailed illustration of the condition data step of the method of FIG. 2.

FIG. 6 a more detailed illustration of the perform analysis step of the method of FIG. 2.

FIG. 7 is a more detailed illustration of the isolated events step shown in FIG. 6.

FIG. 8 is a more detailed illustration of the long-term trend step shown in FIG. 6.

FIG. 9 is a more detailed illustration of the screening analysis step shown in FIG. 7.

FIG. 10 is a more detailed illustration of the build up and drawdown steps shown in FIG. 9.

FIG. 11 is a more detailed illustration of the steady-state analysis step shown in FIG. 9.

FIG. 12 is a more detailed illustration of the select type of analysis step shown in FIG. 2.

FIG. 13 illustrates, in block form, a computer system.

FIG. 14 illustrates, in block form, a computer network/computer system.

### DETAILED DESCRIPTION

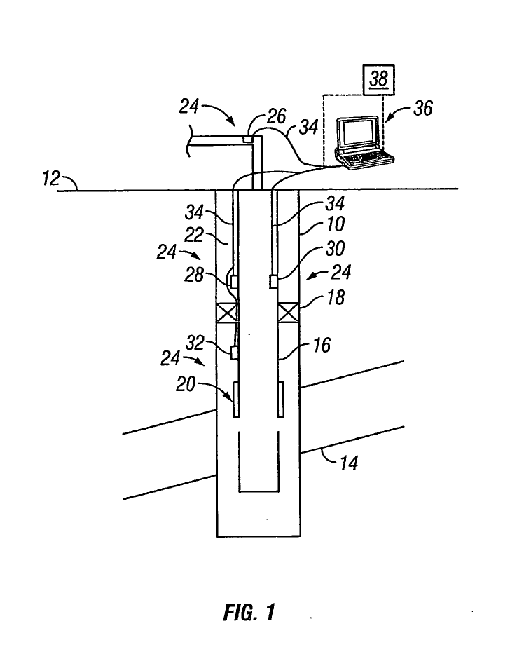

FIG. 1 shows a typical hydrocarbon wellbore 10 that extends from the ground surface 12. Wellbore 10 intersects a hydrocarbon formation 14. A tubular string 16 is typically deployed within the wellbore 10. The string 16 also normally carries various completion equipment, such as a packer 18 and a flow control valve 20 (to name a few). Hydrocarbons from the formation 14 flow into the wellbore 10, into the tubing string 16 (such as through flow control valve 20), and then to the surface. In an alternative embodiment, the hydrocarbons are diverted into the annulus 22 of the wellbore 10 above the packer 18 and flow to the surface therein. In another alternative embodiment, a downhole pump (not shown) may be used to assist in conveying the hydrocarbons to the surface. In yet another embodiment, the wellbore 10 is an injection well in which fluids are injected from the tubing 16 into the formation 14.

Tubing string 16 may be production tubing, coiled tubing, or drill pipe (to name a few). Wellbore 10 can be a land-based or a subsea well.

Sensors are deployed at various locations 24 in the wellbore 10 and production process in order to obtain relevant data regarding the wellbore 10, formation 14, and hydrocarbons. Sensors 26 may be deployed on the surface in communication with the pipeline that receives the hydrocarbons flowing from the wellbore 10. Sensors 28 may be deployed in the annulus 22 above the packer 18. Sensors 30 may be deployed within the tubing string 16. And, sensors 32 may be deployed in the annulus 22 below the packer 18. In another embodiment (not shown), sensors are deployed behind the casing of the wellbore 10. Each sensor 26, 28, 30, 32 may comprise a flow rate sensor (single or multi-phase), a temperature sensor, a distributed temperature sensor, a pressure sensor, an acoustic energy sensor, an electric current sensor, a magnetic field sensor, an electric field sensor, a chemical property sensor, or a fluid sampling sensor. Accordingly, each sensor 26-32 may obtain flow data, temperature data, pressure data, acoustic data, current data, magnetic data, electric data, chemical data, or fluid data (among others). In addition, each sensor location 24 may include more than one type of sensor or each sensor may sense more than one type of data. Each sensor 26-32 obtains its relevant data either continuously or at different time intervals, depending on the type of sensor, power parameters, and requirements of the operator. Each sensor 26-32 may also be an electrical or a fiber optic sensor, among others. The data from the sensors 26-32 is transmitted to a computer system 36 on the surface 12.

There are different ways to transmit the data to the surface 12. For instance, a data line 34 may connect each sensor 26-32 to the computer system 36. The data line may 34 be an electrical, high capacity data transmission line, or it may be a fiber optic line. In one embodiment, each sensor 26-32 is connected to an independent data line 34. In another embodiment, each sensor 26-32 is connected to the same data line 34. Data from the sensors 26-32 may also be transmitted to the surface 12 by way of acoustic, pressure pulse, or electromagnetic telemetry, as these telemetry alternatives are known in the field.

Computer system 36 may be a portable computer, as shown in FIG. 1, that can be removably attached from the sensors 26-32. In this embodiment, a data storage unit 38, which receives data from the sensors 26-32, may be directly attached to the data lines 34, and the portable computer system 36 is then removably attached to the data storage unit 38. With the use of a portable computer system 36, a user may provide a diagnosis and analysis of various wellbores while using a single computer system. Computer system 36 may be a personal computer or other computer.

In other embodiments, the data from sensors 26-32 is transmitted, either on a continuous or a time lapse basis, to a remote location such as the offices of the user. Remote transmission can be performed, for instance, by transmitting the data to a satellite which relays it onto the remote location, transmitting the data through a communication cable to the remote location, or transmitting the data through the internet to a web based location which can be accessed by the user perhaps on a password protected basis. These types of transmission enable the real-time monitoring of the data and wellbore, and also allow a user to take immediate corrective action based on the data received or analysis performed.

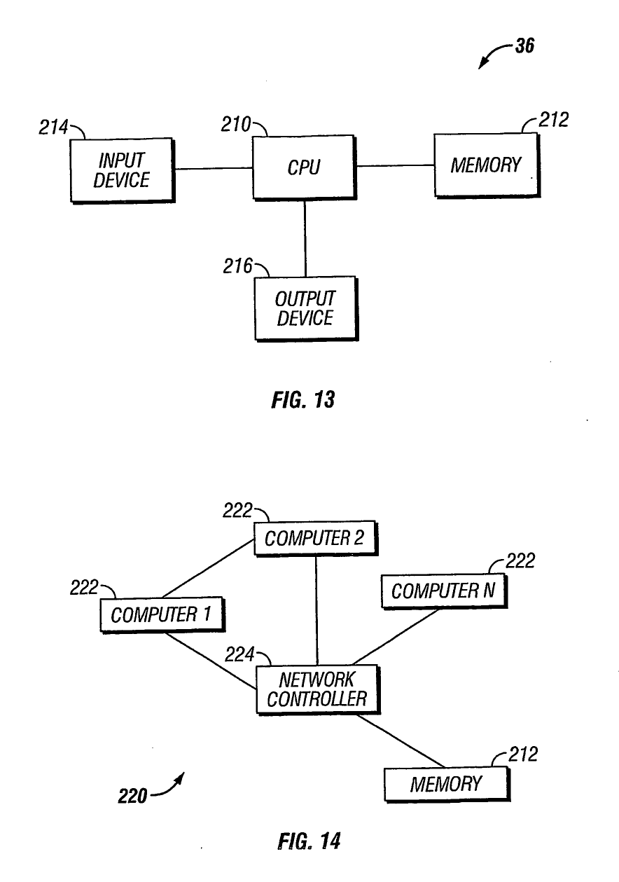

FIG. 13 illustrates in block diagram form an embodiment of hardware that may be used as the computer system 36 and to operate the representative embodiment of the present invention. The computer system 36 comprises a central processing unit (“CPU”) 210 coupled to a memory 212, an input device 214 (i.e., a user interface unit), and an output device 216 (i.e., a visual interface unit). The input device 214 may be a keyboard, mouse, voice recognition unit, or any other device capable of receiving instructions. It is through the input device 214 that the user may make a selection or request as stipulated herein. The output device 216 may be a device that is capable of displaying or presenting data and/or diagrams to a user, such as a monitor. The memory 212 may be a primary memory, such as RAM, a secondary memory, such as a disk drive, a combination of those, as well as other types of memory. Note that the present invention may be implemented in a computer network 220, using the Internet, or other methods of interconnecting computers. An example of a network of computers 222 is shown in block diagram form in FIG. 14. Therefore, the memory 212 may be an independent memory 212 accessed by the network, or a memory 212 associated with on or more of the computers. Likewise, the input device 214 and output device 216 may be associated with any one or more of the computers of the network. Similarly, the system may utilize the capabilities of any one or more of the computers and a central network controller 224. Therefore, a reference to the components of the system herein may utilize any of the individual components in a network of devices. Any other type of computer system may be used. Therefore, when reference is made to “the CPU,” “the memory,” “the input device,” and “the output device,” the relevant device could be any one in the system of computers or network.

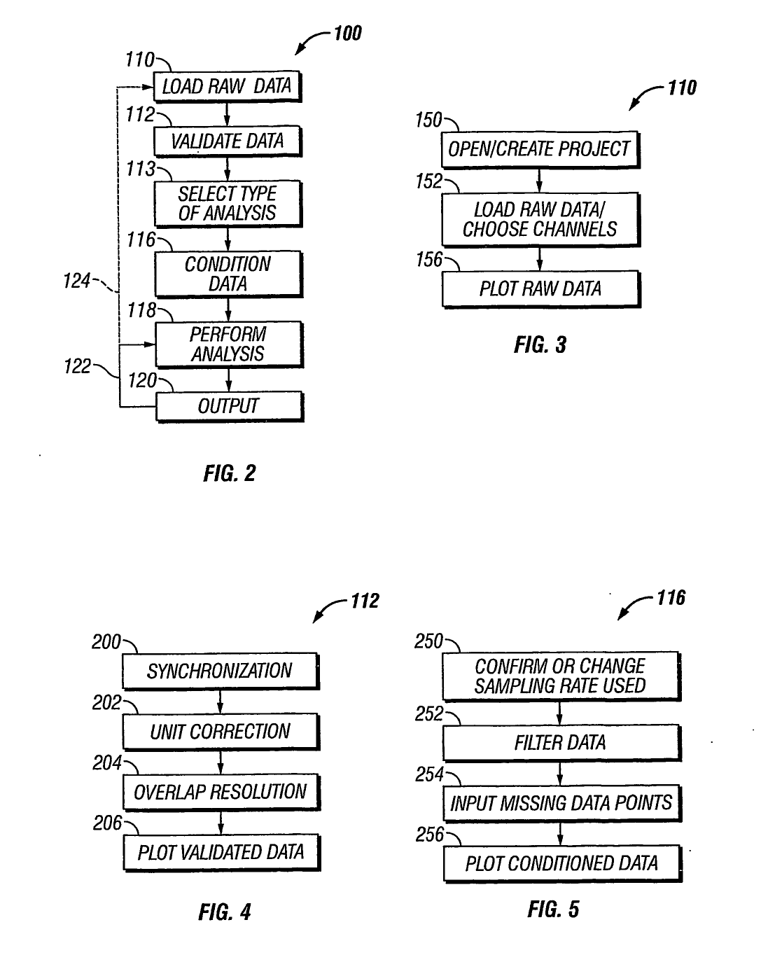

With the data obtained from the sensors 26-32, computer system 36 may perform the general method 100 of the present invention as schematically illustrated in FIG. 2. The general method 100 (and its steps) may be embedded as software routines in memory 212 with the CPU 210 performing the required operations based on the data in the memory 212. Alternatively, the general method 100 may be embedded as hardware logic circuits.

In the first step 110 of the general method 100, computer system 36, at the user's request, loads the raw data from the sensors 26-32, either directly from the data lines 34 or from the data storage unit 38, to the memory 212. In the second step 112, the raw data is validated by the computer system 36. In the third step 113, a user selects the type of analysis that is to be performed on the data. In the fourth step 116, the raw data is then conditioned by the computer system 36. In the fifth step 118, an analysis, as selected by the user, is performed by the computer system 36 on the relevant conditioned data. In the sixth step 120, an output of the selected analysis is provided to the user.

The load raw data step 110 is shown in FIG. 3 in more detail. In the load raw data step 110, at the user's request, the CPU 210 loads the data collected from the sensors 26-32 into the memory 212 of the computer system 36 and may then also perform some preliminary work on the data. A project or file is first created by the CPU 210 at step 150 as requested by the user. Next, the CPU 210 loads the raw data onto the computer system 36 in step 152 and saves the data in memory 212. Depending on the sensors 26-32 and accompanying software used for the sensors, the raw data for specific sensors may already be in certain formats, such as Unitest CD

(ASCII format), Excel Spreadsheet, Data Historian (including P1 and IP21), and relational databases (such as Oracle). In step 152, computer system 36 is able to load the data from the sensors 26-32 in any format that is presented to the computer system 36. Also in step 152, if necessary, a user is able to select the channels (in the case of Data Historian formats) and columns (in the case of Excel Spreadsheet) that should be used by the computer system 36 in later steps for each data stream obtained from a sensor. If the user wishes, the raw data (or parts thereof) may be plotted versus time or versus other parameters in step 156 by the CPU 210. Output plots may be printed or visually displayed by the user on the output device 216.

Typically, the data representative of one physical parameter measured by a sensor is loaded into one “channel” in the memory 212. The data of that channel can then be manipulated and plotted by the user via the CPU 210 at any point in time. Manipulation may include performing statistical analysis, including min-max, average, and standardization.

In one embodiment, the user will only have to select the appropriate channels and columns once for a given data source. The CPU 210 then stores a template in memory 212 for loading data from the relevant data source based on the original choices made by the user. The template is then made available by the CPU 210 to the user to load the next batch of data arriving from the same data source.

It is noted that in performing the load raw data step 110, a user may choose to load the data obtained during specific time periods. For instance, a user may choose to load the data obtained for the past year, or only for one month. Or, of course, a user may choose to load the data obtained during the entire life of the well. Furthermore, the newly loaded data may be appended to previously loaded data to provide a specifically required or comprehensive set of data for the well.

The validate data step 112 is shown in FIG. 4 in more detail. In the validate data step 112, the data is generally transformed into a cleaner set of data using various techniques. In step 200, the relevant data from each of the sensors 26-32 is synchronized with respect to timing differences (such as clock difference, starting time difference, or known wrongly entered time).

It is noted that each data sample should have an associated time stamp. In step 202, the data is then synchronized with respect to units so that data points from the same type of sensors are standardized to the same unit. In this step, units are also assigned to data that is missing units or whose units are not obvious. In step 204, overlap resolution is next performed on data, if there are data streams for the same type of data (downhole pressure, for example) from different sources in time with a period or periods of overlap. If the user wishes, the validated data may be plotted versus time or versus other parameters in step 206 by the CPU 210. Output plots may be printed or visually displayed by the user on the output device 216. Steps 200-206 may be performed manually by the user or automatically by the CPU 210 through an appropriate subroutine stored in memory 212. Moreover, the data may be saved by the CPU 210 on the memory 212 after each step 200-206.

The select type of analysis step 113 is shown in FIG. 12 in more detail. By use of the input device 214, a user may select to perform two types of analysis on the data: a long-term trend 115 and an isolated event 117. The user may elect to conduct one or both of the analysis types. In the long-term trend analysis 115, the data is analyzed to determine any long-term trends of the wellbore 10 and formation 14. Diagnostic plots may be generated based on simple mathematical transformations of the measured data, such as plots of cumulative rate versus time, ratio of gas to oil production rates versus time, and productivity index. In the isolated event analysis 117, data from specific events during the life of a well, such as build-ups, drawn-downs, or shut-ins, is isolated and analyzed to determine parameters of interest. Key reservoir and well parameters (such as skin, near-wellbore damage, permeability-thickness product, or other specific measures of well and reservoir performance) are determined or estimated using different well test analysis techniques.

The condition data step 116 is shown in FIG. 5 in more detail. In the condition data step 116, the data is conditioned to enable a better analysis. In step 250, a user may confirm or change the sampling rate used in the remainder of the analysis for each of the data sets. Data frequency may be reduced by a variety of methods, such as selecting the n^{th} value of the data or using a moving average of the data. It is noted that different parts of the same data set (from one sensor) may have different sampling rates in order to focus or not on specific time periods. In addition, data sets from different sensors may also have different sampling rates. The data is next filtered in step 252 in order to provide a “clean” version of the data for further analysis. Various filtering techniques may be used, including means and median filtering. Filtering removes outliers and “noise” from the data And, in step 254, a user may input any missing data points via the input device 214. The missing data points may be inputted manually by the user, or the user may elect to allow the CPU 210 to interpolate or extrapolate any missing data points such as by the use of linear, cubic spline, or exponential interpolation and extrapolation methods or by using the data from another channel. If the user wishes, the conditioned data may be plotted versus time or versus other parameters in step 256 by the CPU 210. Output plots may be printed or visually displayed by the user on the output device 216. Steps 250-256 may be performed manually by the user or automatically by the CPU 210 through an appropriate subroutine stored in memory 212. Moreover, the data may be saved by the CPU 210 on the memory 212 after each step 250-256.

The type or types of conditioning performed on data (under condition data step 116) depend on the type or types of analysis to be performed on the data in perform analysis step 118. For instance, the isolated event analysis 302 will normally require a higher data frequency than the long-term trend analysis 300, therefore changing the sampling rate used (step 250) may not be performed for the isolated event analysis 302. Alternatively, inputting missing data points (step 254) may need to be used for the isolated event analysis 302 but not for the long-term trend analysis 300.

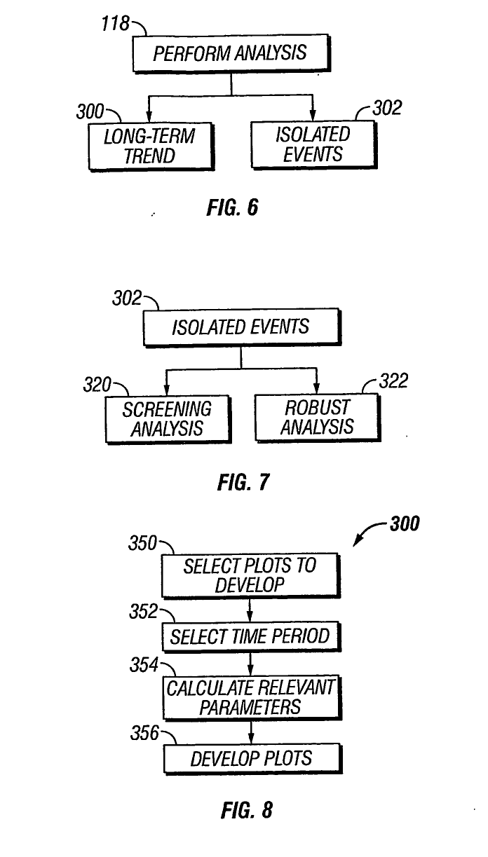

In the perform analysis step 118 as shown in FIG. 6, the types of analysis chosen by the user, long-term trend 300 and/or isolated events 302, are performed as discussed below.

The long-term trend analysis 300 is further illustrated in FIG. 8. In step 350, a user may select the plots or trends he/she wishes the CPU 210 to generate. Many different plots may be developed by the CPU 210 using the data obtained from the sensors 26-32 and the routines stored in memory 212. For instance, the data obtained from the sensors 26-32 (such as surface pressure, downhole pressure, temperature, total flow rate, oil flow rate, water flow rate, and gas flow rate) may be directly plotted against time. Or, additional parameters, as will be discussed in relation to step 354, may be calculated using the data obtained from the sensors 26-32. Next, in step 352, a user selects the time period for which he/she wishes to develop the plot. In step 354, any parameters that must be calculated based on the user's selections in step 350 are calculated.

Examples of these parameters and known equations used to derive such parameters are:

$$P I ( productivity index ) = \frac{{q}_{o}}{{\overline{p}}_{r} - {p}_{wf}} ,$$

where qₒ is the oil flow rate, p̅ᵣ is the reservoir i
pressure, and p_{wf} is the pressure while flowing;

$$G O R ( gas \text{-} oil ratio ) = \frac{{q}_{g}}{{q}_{o}} ,$$

where q_{g} is the gas flow rate and qₒ is the oil flow rate; and

$$W O R ( water \text{-} oil ratio ) = \frac{{q}_{w}}{{q}_{o}} ,$$

where q_{w} is the water flow rate and qₒ is the oil flow rate.
Other parameters may of course be selected, such as wellhead pressure, pressure drop from the bottomhole to the wellhead, pressure drop between the reservoir and the completion, the ratio of the pressure drop between the reservoir and the completion and the oil flow rate, the gas flow rate, the liquid phase flow rate, and the water flow rate. In one embodiment, the user is offered the choice by the CPU 210 to select the parameters to be calculated from a list of parameters stored in memory 212. In another embodiment, the user may define the parameter to be calculated (and then plotted in step 356) by manipulating the listed parameters and/or data. Manipulation can include any mathematical operation. For instance, if one data stream is flow at point A and another data stream is flow at point B, then a user may define a new parameter to be plotted which can be the difference between the flows at points A and B. In step 356, the relevant plots are then developed by the CPU 210 and illustrated for the user on the output device 216. The user can then analyze these long-term plots and observe any long-term trends of the reservoir 14 and wellbore 10.

The isolated event analysis 302 is further illustrated in FIG. 7. For isolated event analysis 302, a user has a choice via the input device 214 to select either a quick screening analysis 320 or a robust analysis 322. The robust analysis 322 itself is not the subject of this invention, although it is incorporated into the overall method 100 and system. There are currently various software packages available in the market that provide the robust theoretical analysis necessary to determine the relevant parameters and to characterize the wellbore or reservoir. These software packages include Schlumberger's Welltest 2000 and Procade. If a user selects the robust analysis 322 option, the CPU 210 exports the data from the sensors 26-32 to the relevant robust analysis programs (which programs may also be stored in memory 212 and driven by the CPU 210). The screening analysis 320 is meant to be a screening tool rather than a wellbore or reservoir characterization tool. The screening analysis 320 provides a user a quick way to screen or select which wellbores or reservoirs the user should subject to the much more time-consuming robust analysis 322.

In order to ensure that the screening analysis 320 is a screening tool and not a more time-consuming characterization tool, certain assumptions and rules may be made in conducting the screening analysis 320. These rules and assumptions may be stored in memory 212 or may be inputted or modified by the user via the input device 214. First, a simple reservoir and wellbore model is assumed and no attempt is made to identify the “true” standard well test model. As is known, each standard model will produce a characteristic “signature” response on plots. Not identifying the true standard model compromises the quality of the model parameters, but since this is a screening and not a characterization tool, this is not a major concern. Also, in order to effectively analyze a build up or a drawdown period, such build up or drawdown period should be preceded by a stable rate period. Since the data from the sensors 26-32 is not from a planned well test, it must therefore be ensured that there is a reasonably stable rate period prior to any build up or drawdown period to be analyzed. In this regard, rate superposition for changing rates may be performed in order to generate an “equivalent” stabilized rate. In addition, characterization tools are typically based on single-phase flow; however, the data from sensors 26-32 may and likely will include multiphase data. For the screening analysis 320, a single-phase analysis is performed on the multiphase data to solve for the effective permeability to the particular phase being considered (and not the absolute permeability one would obtain using single phase data). Moreover, with respect to skin calculations, the same single phase equations can be used to calculate a total skin (including due to multiphase flow).

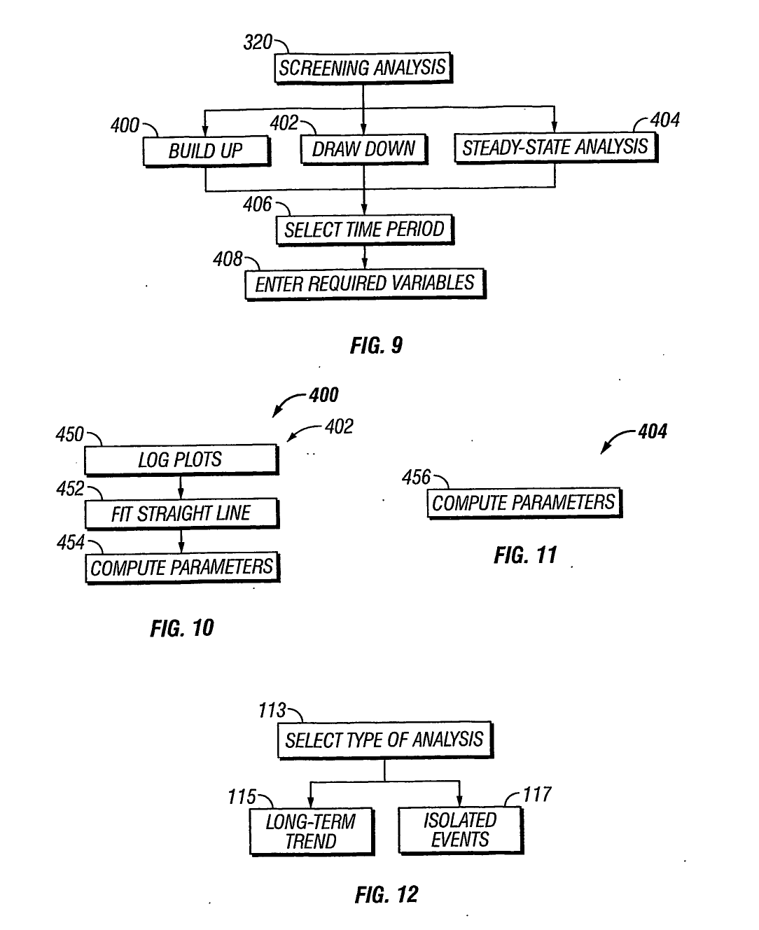

The screening analysis 320 is further illustrated in FIG. 9 and is driven by the CPU 210. A user can select three types of screening analysis via the input device 214: a build up analysis (400), a drawdown analysis (402), or a steady-state analysis (404). As is known in the art, a “build up” typically refers to when the well is shut-in or closed and the bottomhole pressure is allowed to build up within the wellbore. A “drawdown” refers to when the well is then opened releasing the built up pressure in the wellbore. A “steady state” refers to when the wellbore and reservoir are operating and producing without substantial change. Once the user selects the desired type of analysis, the user is then (in step 406) prompted to select the time period for which he/she would like the analysis performed. In one embodiment, the computer system 36 automatically selects the relevant time periods that are relevant for each type of analysis and presents them to the user. For this computer-guided embodiment, a user may define the sensitivity or features that guide the CPU 210 in its automatic selection of the relevant time periods. This computer-guided embodiment is specially useful when the data is representative of a long time period. Next, in step 408, the user is prompted to enter any variables that are required, in addition to the data obtained from the sensors 26-32, to conduct the chosen analysis. Relevant variables may include a fluid model and property (such as a fully compositional PVTi), a well description (such as pressure drop from completion to gauge), basic reservoir properties (such as porosity), total compressibility, reservoir geometry (such as thickness), initial reservoir pressure, fluid viscosities, and borehole radius. In another embodiment, these variables are automatically incorporated from other programs or saved memory 212 accessible to the computer system 36.

FIG. 10 illustrates the additional steps for the build-up analysis (400) and the drawdown analysis (402) steps. In step 450, the log-log and semi-log plots are developed by the CPU 210. These plots, which are known in the prior art and are stored in memory 212, typically plot some function of pressure versus some function of time. For example, in semi-log build-up Horner analysis, a plot is made by the CPU 210 of bottomhole pressure versus the log of Horner time

$$( \frac{{t}_{p} + Δ t}{Δ t} ,$$

where tₚ is the producing time prior to shut-in and Δt is the shut-in time). Next, in step 452, the CPU 210 fits a straight line along the relevant portion of the semi-log and log-log plots to represent the transient of interest. It is noted that in one embodiment type curve matching, which is normally used by true characterization tools to attempt the identification of the reservoir and wellbore model, is not used in the screening analysis 322. And, in step 454, using the relevant data from the sensors 26-32, the variables entered in step 408, the straight line developed in step 452, and relevant equations known in the prior art and stored in memory 212, the relevant reservoir and wellbore variables, including permeability (k), extrapolated pressure (p*), pressure at 1 hour (p₁ₕᵣ), productivity index (PI), and skin (s), are computed by the CPU 210 from the slope of the straight line.

FIG. 11 illustrates the additional step for the steady-state analysis 404. In this step 456, the relevant reservoir and wellbore variables (and specially the productivity index) are computed by the CPU 210 using the relevant data from the sensors 26-32, the variables entered in step 408, and relevant equations known in the prior art and stored in memory 212.

Turning back to FIG. 2, the output step 120 is conducted after the perform analysis step 118. In the output step 120, the CPU 210 displays relevant parameters computed in steps 454 and 456 to the user, and a standardized report with the relevant data, variables, computations, and plots may be printed out by the user via the output device 216. The report may include the calculations and determinations from any characterization tool used in robust analysis step 322, if applicable. Such output may be saved by the user in the memory 212 for use at a later date. Moreover, the data obtained from the sensors 26-32, the shift during any alignment conducted in synchronization step 200, the conditioned data resulting from condition data step 116, and the variables entered in step 408 may be saved by the user in the memory 212 for use at a later date.

As shown by line 122 in FIG. 2, a user may also at any time perform a different analysis on the same data set. Or, as shown by dotted line 124, the user may restart the process with a new data set.

Any plots developed by the computer system 36 may be saved in various file formats, such as jpeg, bmp, and gif on memory 212. Further, any plots developed by the computer system 36 may be exported by the CPU 210 to other software programs, such as Microsoft PowerPoint and Word.

The user may then review and analyze the report and any plots produced during the method 100 to determine whether any action should be taken for the relevant wellbore or reservoir. In an alternative embodiment, computer system 36 may automatically advise the user, such as by an alarm or indicator, that certain wellbore or reservoir parameters are out of pre-determined expected ranges and that corrective action is therefore recommended. By way of example, corrective action can involve closing or opening a flow control valve, injecting a fluid into the well, perforating another portion of the wellbore, stimulating the formation, or actuating devices in the wellbore (such as a packer, perforating gun, etc.). Some of the corrective actions could also be automatically performed by the computer system 36 in that the computer system 36 can send the relevant commands to the appropriate devices in the wellbore by way of known telemetry techniques (such as pressure pulse, acoustic, electromagnetic, fiber optic, or electric cable).

As previously described, instructions of the various routines discussed herein (such as the method 10 performed by the computer system 36 and subparts thereof including equations and plots) may comprise software routines that are stored on memory 212 and loaded for execution on the CPU 210. Data and instructions (relating to the various routines and inputted data) are stored in the memory 212. The memory 212 may include semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method to retrieve and analyze data from a wellbore, comprising:
locating at least one sensor in the wellbore or in communication with fluids produced from the wellbore;
measuring at least one parameter of interest with the at least one sensor;
retrieving data that is indicative of the at least one parameter of interest from the at least one sensor;
loading the data into a computer system; and
analyzing the data with the computer system to indicate trends in the wellbore.

2. The method of claim 1, wherein the locating step comprises locating a plurality of sensors, the measuring step comprises measuring at least one parameter of interest with the plurality of sensors, and the retrieving step comprises retrieving the data that is indicative of the at least one parameter of interest from the plurality of sensors.

3. The method of claim 1, wherein the measuring step comprises measuring a plurality of parameters of interest with the at least one sensor, and the retrieving step comprises retrieving the data that is indicative of the plurality of parameters of interest from the at least one sensor.

4. The method of claim 1, wherein the locating step comprises locating the at least one sensor in a pipeline that receives the fluids flowing from the wellbore.

5. The method of claim 1, wherein the locating step comprises locating the at least one sensor within a tubing string deployed in the wellbore.

6. The method of claim 1, wherein the locating step comprises locating the at least one sensor exterior to a tubing string deployed in the wellbore.

7. The method of claim 6, wherein the locating step comprises locating the at least one sensor above a packer attached to the tubing string.

8. The method of claim 6, wherein the locating step comprises locating the at least one sensor below a packer attached to the tubing string.

9. The method of claim 1, wherein the at least one parameter of interest comprises pressure, temperature, flow, a chemical property, acoustic data, current, magnetic data, electric data, or fluid data.

10. The method of claim 1, wherein the retrieving data step comprises transmitting the data from the at least one sensor through a data line.

11. The method of claim 1, further comprising selecting a specific period of time for which the data is loaded in the loading step.

12. The method of claim 1, further comprising validating the data prior to the analyzing step.

13. The method of claim 12, wherein the validating step comprises synchronizing the data with respect to timing differences.

14. The method of claim 12, wherein the validating step comprises synchronizing the data with respect to time.

15. The method of claim 1, further comprising conditioning the data prior to the analyzing step.

16. The method of claim 15, wherein the conditioning step comprises changing the sampling rate that is to be used in the analyzing step.

17. The method of claim 15, wherein the conditioning step comprises filtering the data to remove noise from the data.

18. The method of claim 15, wherein the conditioning step comprises inputting missing data points.

19. The method of claim 18, wherein the inputting step comprises manually inputting the missing data points.

20. The method of claim 18, wherein the inputting step comprises allowing the computer system to estimate the missing data points.

21. The method of claim 15, wherein the conditioning step differs depending on whether the data is analyzed to determine a long-term trend or an isolated event.

22. The method of claim 1, wherein the analyzing step comprises performing a long-term trend analysis of the wellbore.

23. The method of claim 22, wherein the performing a long-term trend analysis step comprises plotting the data against time.

24. The method of claim 22, wherein the performing a long-term trend analysis step comprises calculating at least one parameter using the data.

25. The method of claim 24, wherein the calculated parameter comprises one of productivity index, gas-oil ratio, water-oil ratio, pressure at wellhead, pressure drop from the bottomhole to the wellhead, pressure drop between the reservoir and the completion, ratio of pressure drop between the reservoir and the completion and the oil flow rate, oil flow rate, gas flow rate, liquid phase flow rate, or water flow rate.

26. The method of claim 1, wherein the analyzing step comprises performing an isolated event analysis of the wellbore.

27. The method of claim 26, wherein the performing an isolated event analysis step comprises conducting a robust analysis of the wellbore.

28. The method of claim 27, wherein the conducting a robust analysis step comprises exporting the data to a program that conducts the robust analysis step.

29. The method of claim 26, wherein the performing an isolated event analysis step comprises conducting a quick screening analysis of the wellbore or reservoir intersected by the wellbore.

30. The method of claim 29, wherein the conducting a quick screening analysis step comprises conducting a build-up analysis, a drawdown analysis, or a steady-state analysis.

31. The method of claim 30, wherein the conducting a quick screening analysis step comprises plotting some function of pressure versus some function of time for the build-up and drawdown analysis.

32. The method of claim 30, further comprising, for the build-up and drawdown analysis, ensuring that a steady-state period precedes any relevant build-up or drawdown period.

33. The method of claim 29, wherein the conducting a quick screening analysis step comprises calculating permeability, skin, or productivity index.

34. The method of claim 29, wherein the computer system conducts the quick screening analysis using certain rules and assumptions to ensure the analysis is not a characterization tool.

35. The method of claim 1, wherein multiple wellbores are analyzed.

36. The method of claim 1, further comprising sounding an alarm if a data or parameter of interest is outside of an expected range.

37. The method of claim 1, further comprising taking corrective action as a result of the analyzing step.

38. A method to screen wellbores in order to determine which wellbores should be subjected to a well test analysis tool, comprising:
locating at least one sensor in the wellbore or in communication with fluids produced from the wellbore;
obtaining data from the at least one sensor that is indicative of at least one parameter of interest;
conducting a quick screening analysis of the data; and
determining whether to subject the data to a well test analysis tool depending on the outcome of the conducting step.

39. The method of claim 38, wherein the conducting a quick screening analysis step is performed using a computer system.

40. The method of claim 39, wherein the conducting a quick screening analysis step comprises calculating permeability, skin, or productivity index of the wellbore.

41. The method of claim 39, wherein the conducting a quick screening analysis step comprises conducting a build-up analysis, a drawdown analysis, or a steady-state analysis.

42. The method of claim 41, wherein the conducting a quick screening analysis step comprises plotting some function of pressure versus some function of time for the build-up and drawdown analysis.

43. The method of claim 41, further comprising, for the build-up and drawdown analysis, ensuring that a steady-state period precedes any relevant build-up or drawdown period.

44. The method of claim 38, wherein the computer system conducts the quick screening analysis using certain rules and assumptions to ensure the analysis is not a characterization tool.

45. A system to retrieve and analyze data from a wellbore, comprising:
at least one sensor located in the wellbore or in communication with fluids produced from the wellbore, the at least one sensor measuring at least one parameter of interest;
a computer system adapted to retrieve data that is indicative of the at least one parameter of interest from the at least one sensor; and
the computer system adapted to analyze the data to indicate trends in the wellbore.

46. The system of claim 45, wherein a plurality of sensors are located in the wellbore or in communication with fluids produced from the wellbore.

47. The system of claim 45, wherein the at least one parameter of interest comprises pressure, temperature, flow, a chemical property, acoustic data, current, magnetic data, electric data, or fluid data.

48. The system of claim 45, wherein the data is validated prior to it being analyzed.

49. The system of claim 45, wherein the data is conditioned prior to it being analyzed.

50. The system of claim 45, wherein the computer system is adapted to perform a long-term trend analysis of the wellbore.

51. The system of claim 45, wherein the computer system is adapted to perform an isolated event analysis of the wellbore.

52. The system of claim 51, wherein the performing an isolated event analysis step comprises conducting a quick screening analysis of the wellbore or reservoir intersected by the wellbore.

53. The system of claim 52, wherein the conducting a quick screening analysis step comprises conducting a build-up analysis, a drawdown analysis, or a steady-state analysis.

54. The system of claim 52, wherein the computer system conducts the quick screening analysis using certain rules and assumptions to ensure the analysis is not a characterization tool.

55. The system of claim 45, wherein multiple wellbores are analyzed.

56. The system of claim 45, further comprising an alarm that sounds if a data or parameter of interest is outside of an expected range.

57. The system of claim 45, wherein corrective action is taken as a result of the analysis performed by the computer system.

58. A system to retrieve and analyze data from a wellbore, comprising:
at least one central processing unit (CPU);
at least one memory in communication with the CPU;
the at least one CPU adapted to load data from a wellbore, the data indicative of at least one parameter of interest; and
the at least one CPU adapted to analyze the data by using routines stored in the at least one memory in order to indicate trends in the wellbore.

59. A method to screen wellbores in order to determine which wellbores should be subjected to a well test analysis tool, comprising:
using a central processing unit (CPU) to load data, the data indicative of at least one parameter of interest in a wellbore;
conducting a quick screening analysis of the data with the CPU;
restricting the analysis with certain rules and assumptions to ensure the analysis is not a characterization tool; and
determining whether to subject the data to a well test analysis tool depending on the outcome of the conducting step.
